(19) United States
(12) Patent Application Publication
(10) Pub. No.: US 2011/0012496 A1
(43) Pub. Date: Jan. 20, 2011

(54) Thermal sensitive image display

(75) Inventors: Yu-Yang Chang, Hsinchu County (TW); Chen-Pang Kung, Taoyuan County (TW); Yu-Han Chien, Taipei City (TW); Chung-I Lee, Taipei City (TW); Cheng-Chung Lee, Hsinchu City (TW)

Correspondence Address: QUINTERO LAW OFFICE, PC, 615 Hampton Dr, Suite A202, Venice, CA, 90291, US

(73) Assignee: INDUSTRIAL TECHNOLOGY RESEARCH INSTITUTE, Hsinchu (TW)

(21) Appl. No.: 12/703,517

(22) Filed: Feb. 10, 2010

(30) Foreign Application Priority Data
Jul. 16, 2009 (TW) TW098124052

(51) Int. Cl. H01K 1/30; H01J 1/00

(52) U.S. Cl. 313/111; 313/235; 313/113

(57) ABSTRACT

A thermal sensitive display is disclosed, including a substrate, a first electrode and a second electrode perpendicular with each other over the substrate, a electric heat converting layer between the first electrode and the second electrode, and a heat induced color changing layer, heated by the electric heat converting layer to display pictures.

### CROSS REFERENCE

This Application claims priority of Taiwan Patent Application No. 098124052, filed on Jul. 16, 2009, the entirety of which is incorporated by reference herein.

### BACKGROUND OF THE INVENTION

1. Field of the Invention

The invention relates to a display apparatus and more particularly relates to a thermal sensitive image display.

2. Description of the Related Art

Due to environmental consciousness, green technology related to fabricating image displays and materials used therein have become popular. Specifically, image displays should be as environmentally friendly as possible.

Thermal sensitive paper has been developed, wherein contents can be written into a thermal sensitive paper by a thermal writing apparatus and the content can be erased and changed. The thermal sensitive paper uses transparent dyes and developers, and as shown in FIG. 1, when the transparent dyes and the developers link up due to heating, a colored state is displayed, and when a heating process is performed again for separating the dyes and the developers, the color disappears for the material to return to a transparent discolored state. Alternatively, when the linked dyes and the developers are quenched, the color of the thermal sensitive thin film is fixed. The linking and separating procedure occur at different heated temperatures, wherein the temperature for linking and coloring is about 140° C.˜180° C. and the temperature for discoloring is about 20˜40° C. lower than the linking and coloring temperature. A thermal sensitive rewritable paper has been developed, in which formula of the developer is greatly improved, coagulating strength between coloring agents are improved and distributing strength between coloring agents and transparent dyes has been improved when compared to the thermal sensitive paper.

### BRIEF SUMMARY OF INVENTION

The invention applies rewritable and erasable thermal sensitive macromolecules as a display agent and designs the panel structure to form a new type coloring display with high reflectivity, high contrast and bi-stability.

The invention provide a thermal sensitive display, comprising a substrate, a first electrode and a second electrode perpendicular with each other over the substrate, a electric heat converting layer between the first electrode and the second electrode, and a heat induced color changing layer, heated by the electric heat converting layer to display pictures.

### BRIEF DESCRIPTION OF DRAWINGS

The invention can be more fully understood by reading the subsequent detailed description and examples with references made to the accompanying drawings, wherein:

FIG. 1 shows the mechanism of a thermal sensitive thin film.

FIGS. 2A˜2F show a method for forming a passive matrix planar type top emission black and white thermal sensitive display of an embodiment of the invention.

FIG. 2G shows coloring of the passive matrix planar type top emission black and white thermal sensitive display of FIG. 2F.

FIGS. 3A˜3D show top views of intermediate stages of a passive matrix planar type top emission black and white thermal sensitive display of an embodiment of the invention.

FIGS. 4A˜4E show a method for forming a passive matrix vertical type top emission black and white thermal sensitive display of an embodiment of the invention.

FIGS. 5A˜5D show top views of intermediate stages of a passive matrix vertical type top emission black and white thermal sensitive display of an embodiment of the invention.

FIG. 6A and FIG. 6B show a planar type thermal sensitive display of an embodiment of the invention.

FIG. 7A and FIG. 7B show a vertical type thermal sensitive display of an embodiment of the invention.

FIG. 8 shows a planar type top emission colorful thermal sensitive display of an embodiment of the invention.

FIG. 9 shows a planar type top emission colorful thermal sensitive display of an embodiment of the invention.

FIG. 10 shows a planar type top emission colorful thermal sensitive display of an embodiment of the invention.

FIG. 11 shows a planar type bottom emission colorful thermal sensitive display of an embodiment of the invention.

FIG. 12 shows a planar type bottom emission colorful thermal sensitive display of an embodiment of the invention.

FIG. 13 shows a planar type bottom emission colorful thermal sensitive display of further another embodiment of the invention.

### DETAILED DESCRIPTION OF INVENTION

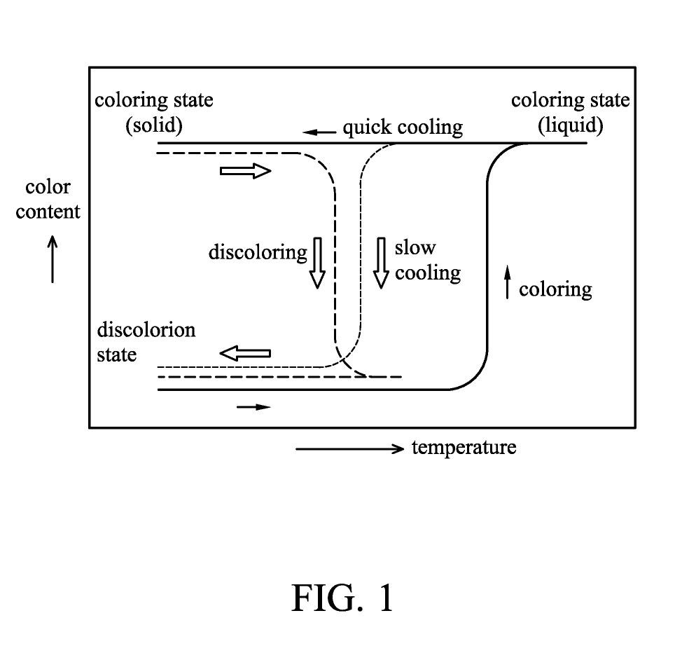

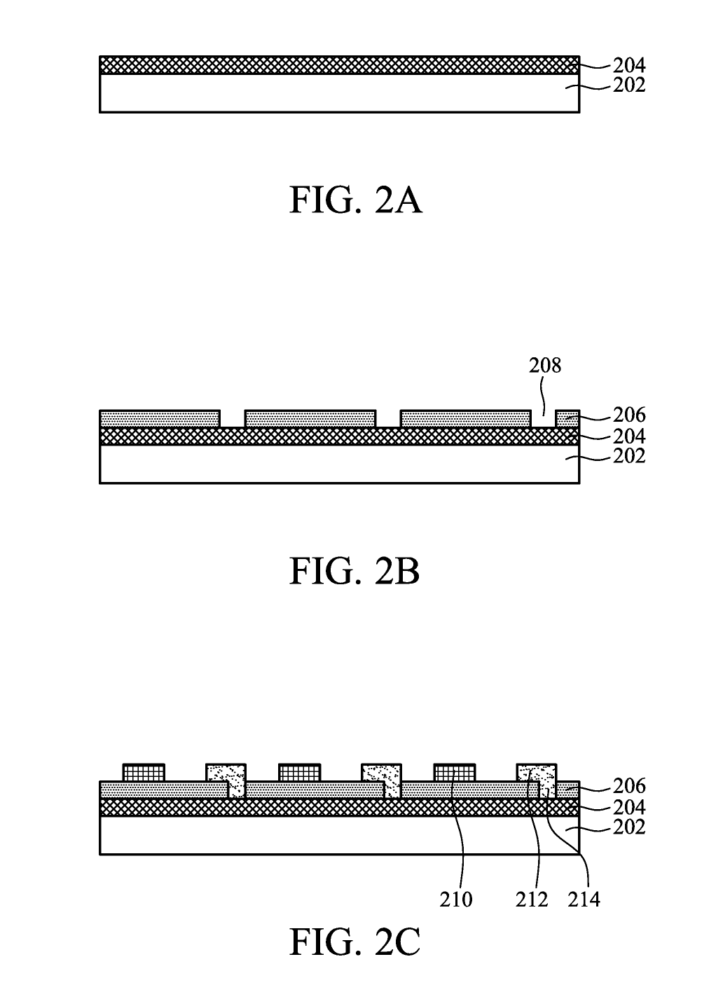

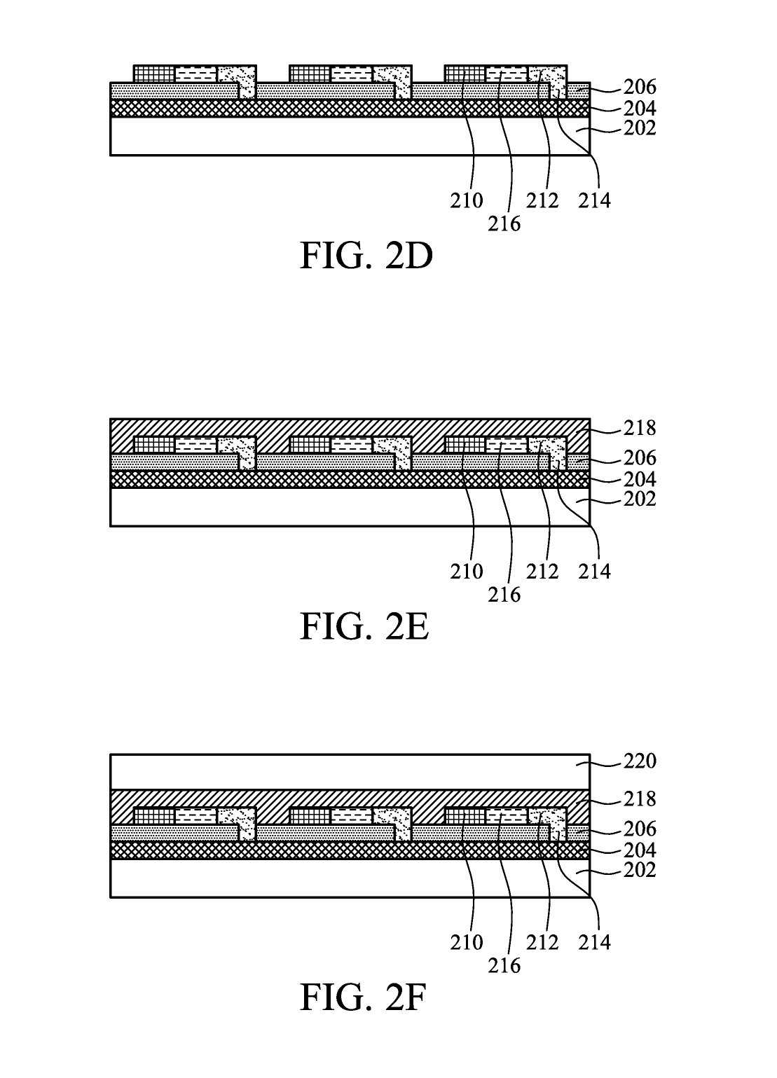

The invention provides a new display using a thermal sensitive mechanism. This display can be designed with different structures to perform black and white or colorful. A method for forming a passive matrix planar type top emission black and white thermal sensitive display of an embodiment of the invention is illustrated in accordance with FIGS. 2A˜2F. Referring to FIG. 2A, a substrate 202 is provided and a first electrode 204 is formed thereon. Referring to FIG. 2B, a dielectric layer 206 is formed on the first electrode 204 and the substrate 202, followed by patterning of the dielectric layer 206 to form a plurality of openings 208. Referring to FIG. 2C, a second electrode 210 and a third electrode 212 are formed on the dielectric layer 206 by a deposition and lithography process, wherein the third electrode 212 is filled into the openings to form plugs 214 electrically connecting the first electrode 204 to the third electrode 212. Referring to FIG. 2D, an electric heat converting layer 216 such as tungsten or semiconductor material is formed between the second electrode 210 and the third electrode 212. Referring to FIG. 2E, a white reflective layer 218 such as a TiO₂ layer is formed on the second electrode 210, the third electrode 212, the electric heat converting layer 216 and the dielectric layer 206. Referring to FIG. 2F, a heat induced color changing layer 220, such as a Leuco dye, is formed on the reflective layer 218. It is noted that the heat induced color changing layer 220 is formed by the material having the mechanism illustrated in FIG. 1. When the dye and the developer of the heat induced color changing layer 220 is linked by heat, black color is displayed, as shown in pattern 221 in FIG. 2G. When the heat induced color changing layer 220 is heated again to separate the dye and the developer, the black pattern 221 disappears. Therefore, the embodiment can apply current to a specific pixel using a first electrode 204 and a second electrode 210, which are perpendicular, for applying heat to the heat induced color changing layer 220 through the electric heat converting layer 216. The light source is environment light, and viewers are over the panel and the electrodes are arranged horizontally in the embodiment. Therefore, the display of the embodiment is called a passive matrix planar type top emission black and white thermal sensitive display.

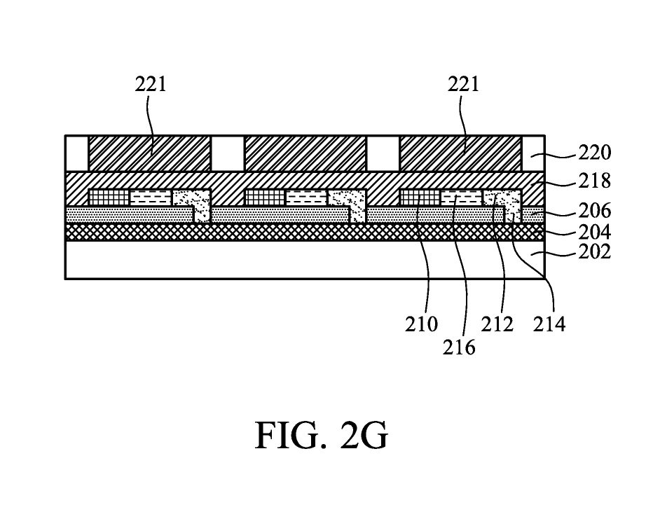

The top views of the preciously described process steps are further described in accordance with FIGS. 3A˜3D First, referring to FIG. 3A, wherein FIG. 3A shows a top view of FIG. 2A, the first electrodes 204 extends in a horizontal direction and are parallel with each other. Referring to FIG. 3B, wherein FIG. 3B shows a top view of FIG. 2B, a plurality of openings 208 are formed in the dielectric layer 206 to expose the first electrode 204. Referring to FIG. 3C, wherein FIG. 3C shows a top view of FIG. 2D, the second electrodes 210 extend in a vertical direction and the electric heat converting layer 216 is interposed between the second electrode 210 and the third electrode 212. Referring to FIG. 3D, wherein FIG. 3D shows a top view of FIG. 2E, the reflective layer 218 covers the second electrode 210, the electric heat converting layer 216, the third layer 212 and the dielectric layer 206.

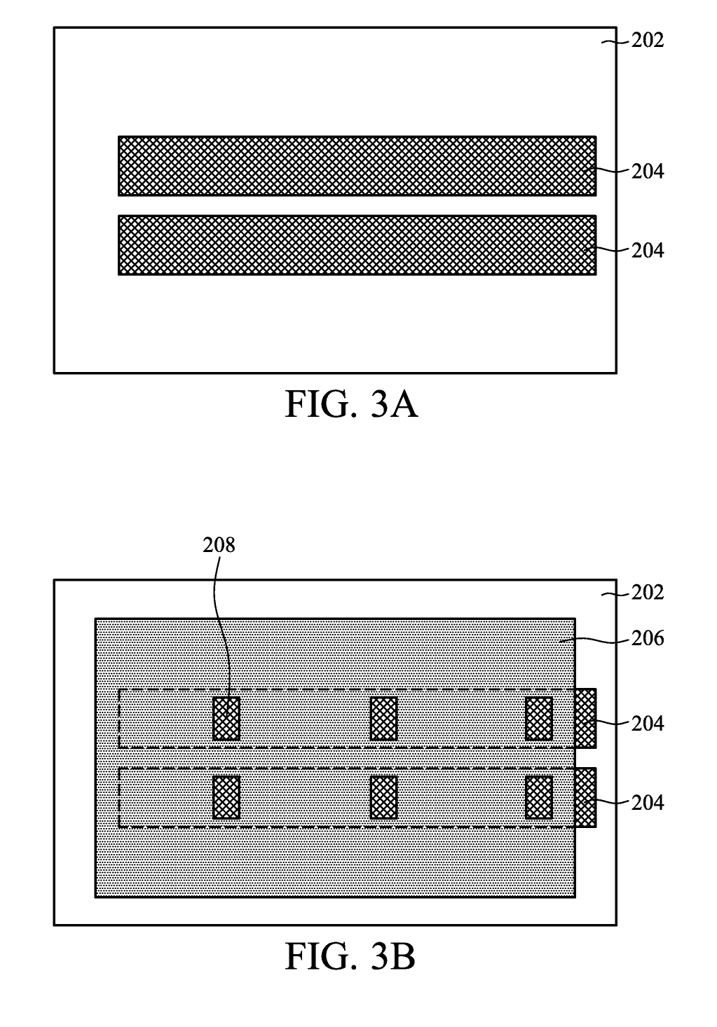

A method for forming a passive matrix vertical type top emission black and white thermal sensitive display of an embodiment of the invention is illustrated in accordance with FIGS. 4A˜4D. Unlike the embodiment shown in FIG. 2A˜FIG. 2G, electrodes of the thermal sensitive display are arranged in a direction vertical to the substrate surface in the embodiment. Referring to FIG. 4A, a substrate 402 is provided and a first electrode 404 is formed thereon. Referring to FIG. 4B, an electric heat converting layer 406 is formed on the first electrode 404 and the substrate 402. The electric heat converting layer 406 is required to have a dielectric characteristic to prevent short between the first electrode 404 and an another electrode formed thereafter. For example, the electric heat converting layer 406 can be a semiconductor layer. Referring to FIG. 4C, a second electrode 408 is formed on the electric heat converting layer 406, wherein the second electrode 408 is arranged in a direction perpendicular to the first electrode 404. Referring to FIG. 4D, a white reflective layer 410, such as a TiO₂ layer, is formed on the second electrode 408. Referring to FIG. 4E, a heat induced color changing layer 412 is formed on the reflective layer 410. It is noted that heat induced color changing layer 412 is formed by the material having the mechanism illustrated in FIG. 1. For example, the heat induced color changing layer 412 is a Leuco dye. An electric current can flow along a direction perpendicular to the substrate surface through the first electrode 404 and the electric heat converting layer 406 to the second electrode 408. Therefore, the electric heat converting layer 406 in a specific pixel can be applied with current to heat the heat induced color changing layer 412 for the pixel to be change to a black color. Accordingly, a black and white pattern 413 is presented, as shown in FIG. 4E.

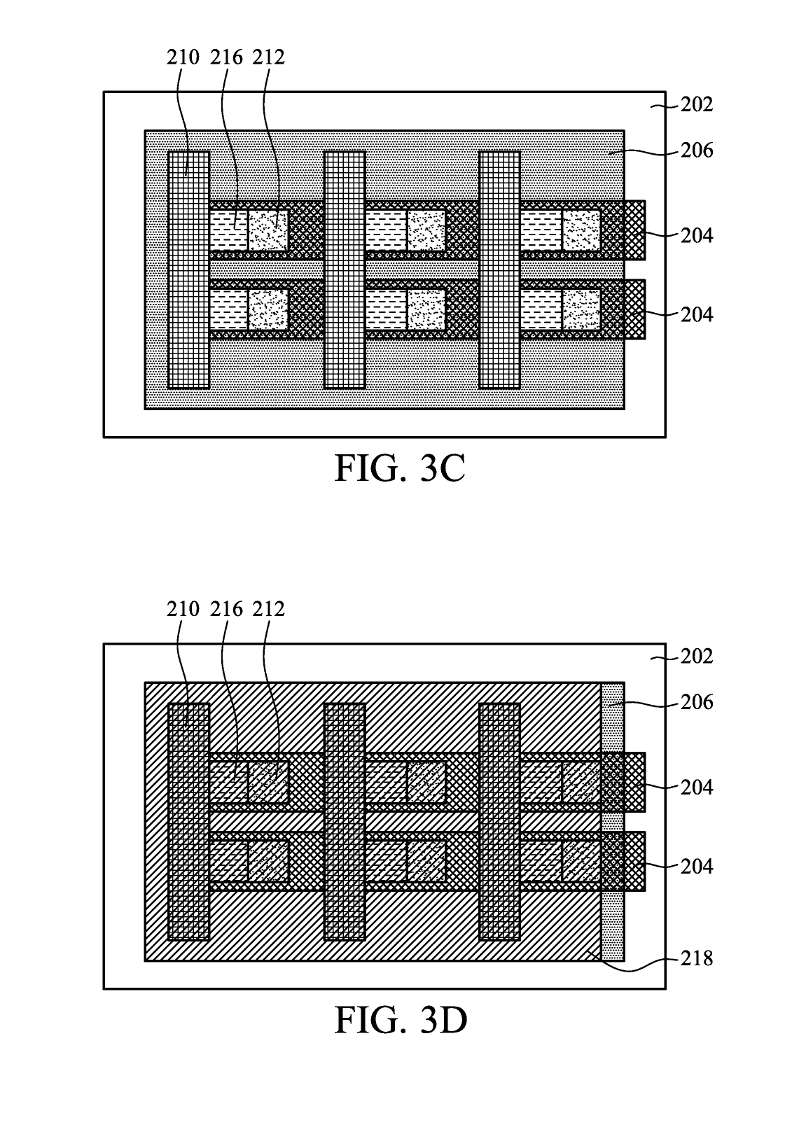

The top views of the described process steps are further described in accordance with FIGS. 5A˜5D. First, referring to FIG. 5A, wherein FIG. 5A shows a top view of FIG. 4A, the first electrodes 404 extend in a horizontal direction and are parallel with each other. Referring to FIG. 5B, wherein FIG. 5B shows a top view of FIG. 4B, the electric heat converting layer 406 covers the first electrode 404 and the substrate 402. Referring to FIG. 5C, wherein FIG. 5C shows a top view of FIG. 4C, the second electrodes 408 extends in a vertical direction and are parallel with each other. Referring to FIG. 5D, wherein FIG. 5D shows a top view of FIG. 4D, the reflective layer 410 covers the second electrode 408 and the electric heat converting layer 406.

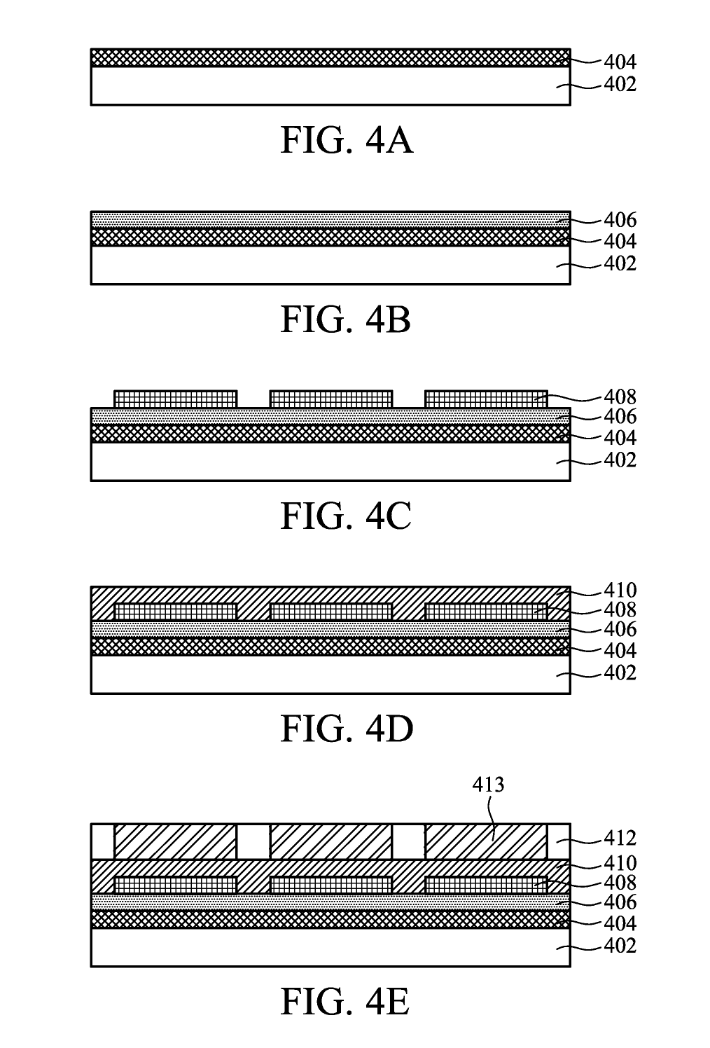

The displays described are top emission thermal sensitive display. The invention further provides a bottom emission thermal sensitive display in another embodiment. A planar type bottom emission thermal sensitive display is illustrated in accordance with FIG. 6A and FIG. 6B. Unlike the top emission thermal sensitive display shown in FIG. 2F wherein the reflective layer is arranged over the heat induced color changing layer, the reflective layer is arranged under the heat induced color changing layer in this embodiment. Referring to FIG. 6A, a first electrode 604 is disposed on a substrate 602. A dielectric layer 606 is disposed on the substrate 602 and the first electrode 604. A second electrode 608, an electric heat converting layer 614 and a third electrode 610 are disposed on the dielectric layer 606, wherein the third electrode 610 electrically connects the first electrode 604 via a plug 612. A heat induced color changing layer 616 is disposed on the second electrode 608, the electric heat converting layer 614, the third electrode 610 and the dielectric layer 606. A reflective layer 618 is disposed on the heat induced color changing layer 616. The light source is environment light and viewers are under the panel in the embodiment. The substrate 602, the first electrode 604, the dielectric layer 606, the second electrode 608, the third electrode 610 and the electric heat converting layer 614 are preferably formed of transparent materials for light to pass through these layers. For example, the first electrode 604, the second electrode 608 and the third electrode 610 can comprise indium tin oxide (ITO) and the dielectric layer 606 can comprise silicon oxide. As shown in FIG. 6B, the embodiment can apply current to a specific pixel by the perpendicular first electrode 604 and second electrode 608 for the electric heat converting layer 614 in the pixel to heat the heat induced color changing layer 616 to display a black pattern 617.

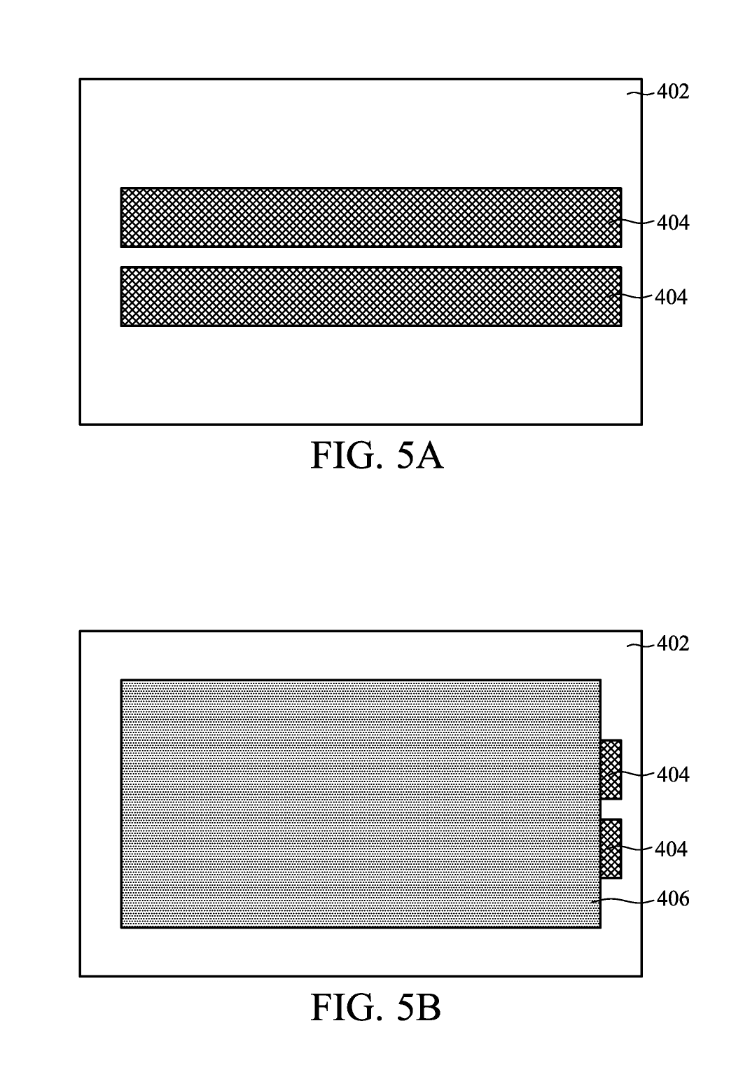

A vertical type bottom emission thermal sensitive display of another embodiment of the invention is illustrated in accordance with FIG. 7A and FIG. 7B. Unlike the top emission thermal sensitive display shown in FIG. 4D which arranges the reflective layer over the heat induced color changing layer, the embodiment arranges the reflective layer under the heat induced color changing layer. Referring to FIG. 7A, a first electrode 704 is disposed on a substrate 702. An electric heat converting layer 706 is disposed on the first electrode 704 and the substrate 702. A second electrode 708 is disposed on the electric heat converting layer 706. A heat induced color changing layer 710 is disposed on the second electrode 708 and the electric heat converting layer 706. A reflective layer 712 is disposed on the heat induced color changing layer 710. The light source is environment light and viewers are under the panel in the embodiment. The first electrode 704, the second electrode 708 and the electric heat converting layer 706 are preferably formed of transparent materials for light to pass through these layers. For example, the first electrode 704 and the second electrode 708 can comprise indium tin oxide (ITO). As shown in FIG. 7B, the embodiment can apply current to a specific pixel by the perpendicular first electrode 704 and second electrode 708 for the electric heat converting layer 706 in the pixel between the first electrode 704 and the second electrode 708 to heat the heat induced color changing layer 710 to display a black pattern 713.

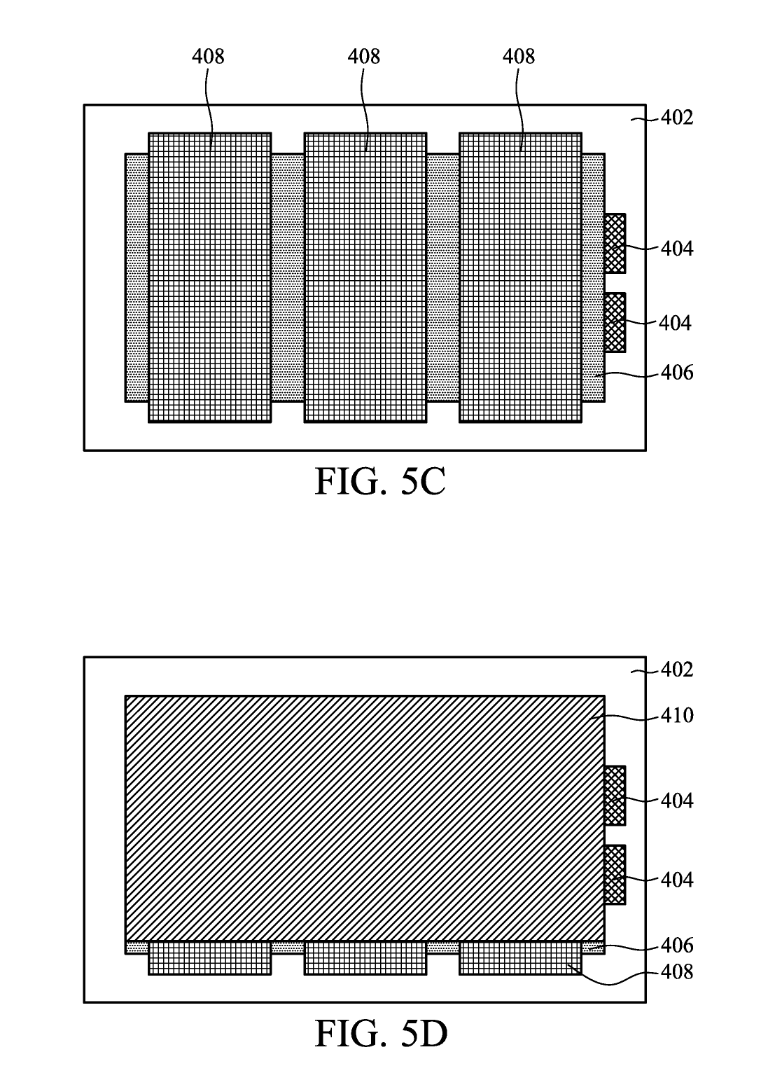

The invention is not limited to black and white displays described, but also comprises colorful displays. The planar type top emission colorful thermal sensitive display is illustrated in accordance with FIG. 8. Unlike the black and white thermal sensitive display shown in FIG. 2F, the reflective layer includes at least three colorful portions in the embodiment. Referring to FIG. 8, a first electrode 804 is disposed on a substrate 802. A dielectric layer 806 is disposed on the first electrode 804 and the substrate 802. A second electrode 818, an electric heat converting layer 819 and a third electrode 820 are disposed on the dielectric layer 806, wherein the third electrode 820 electrically connects a first electrode 804 through a plug 822. The first electrode 804 and the second electrode 818 are perpendicular with each other for locating pixels. The second electrode 818 and the third electrode 820 are formed of the same material and are fabricated and patterned simultaneously. In the embodiment, each pixel includes at least three sub-pixel regions, such as a first sub-pixel region 824, a second sub-pixel region 826 and a third sub-pixel region 828. In the embodiment, the reflective layer 808 includes three or more colorful portions corresponding to each single sub-pixel region. For example, a first colorful portion 810 is disposed in the first sub-pixel region 824, a second colorful portion 812 is disposed in the second sub-pixel region 826 and a third colorful portion 814 is disposed in the third sub-pixel region 828. The colorful portions of the reflective layer can be a TiO₂ metal layer doped with dyes or pigments. In an example of the invention, the first colorful portion 810 is red, the second colorful portion 812 is green and the third colorful portion 814 is blue. It is noted that the invention is not limited to the three original colors (red, green and blue). Another embodiment of the invention can comprise four sub-pixel regions and four corresponding colorful portions of reflective layers, wherein the first color can be cyan, the second color can be magenta, the third color can be yellow and the fourth color can be black. In addition, if the reflective layer 808 is thermally conductive in the embodiment, formation of a heat isolating layer 816 to isolate adjacent sub-pixels is required. For example, the heat isolating layer 816 can be made of ceramic or isinglass, etc. Referring to FIG. 8 again, a heat induced color changing layer 830 is disposed on the first colorful portion 810, the second colorful portion 812 and the third colorful portion 814 of the reflective layer. The first colorful portion 810, the second colorful portion 812 and the third colorful portion 814 of the reflective layer 808 can be formed in different steps after formation of the heat isolating layer 816.

Accordingly, light with various colors can be generated after reflected by the reflective layer 808 in the embodiment. The heat induced color changing layer 830 is heated by the electric heat converting layer 819 for the heat induced color changing layer 830 to present black patterns or transparent patterns. When the heat induced color changing layer 830 is transparent, a white color pixel can be presented by mixing of light passing the three color reflective layer. The light source is the environment light, viewers are over the display and the electrodes are arranged horizontally in the embodiment. Therefore, the display of the embodiment is called a planar type top emission colorful thermal sensitive display.

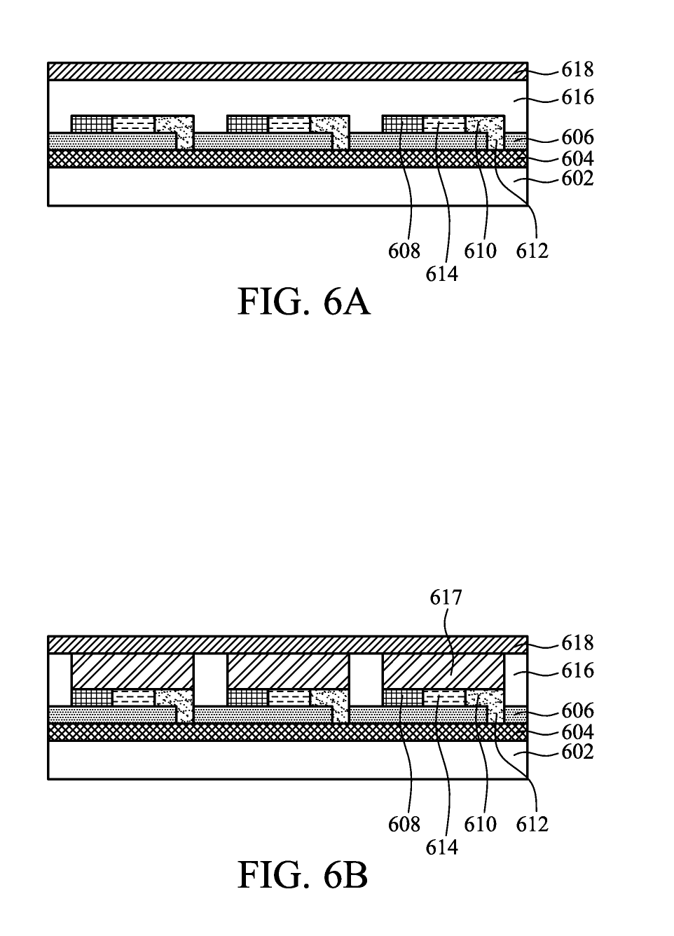

The planar type bottom emission thermal sensitive display is illustrated in accordance with FIG. 9. Unlike the thermal sensitive display shown in FIG. 8, the reflective layer is formed over the heat induced color changing layer in the embodiment. Referring to FIG. 9, a first electrode 904 is disposed on a substrate 902. A dielectric layer 906 is disposed on the first electrode 904 and the substrate 902. A second electrode 908, an electric heat converting layer 910 and a third electrode 912 are disposed on the dielectric layer 906, wherein the third electrode 912 is electrically connected to the first electrode 904 through a plug 914. The first electrode 904 and the second electrode 908 are perpendicular with each other for locating pixels. The second electrode 908 and the third electrode 912 are formed of the same material and are fabricated and patterned simultaneously. A heat induced color changing layer 916 is disposed on the second electrode 908, the electric heat converting layer 910 and the third electrode 912. A reflective layer 924 is disposed on the heat induced color changing layer 916. The reflective layer comprises at least three colorful portions, wherein a first colorful portion 918 is disposed in a first sub-pixel region 926, a second colorful portion 920 is disposed in a second sub-pixel region 928 and a third colorful portion 922 is disposed in a third sub-pixel region 930. The light source is the environment light, viewers are under the display and the electrodes are arranged horizontally in the embodiment. Therefore, the display of the embodiment is called a planar type bottom emission colorful thermal sensitive display. It is noted that the first electrode 904, the second electrode 908, the third electrode 912, the electric heat converting layer 910, the dielectric layer 906 and the substrate 902 are required to be transparent for light to pass through these layers.

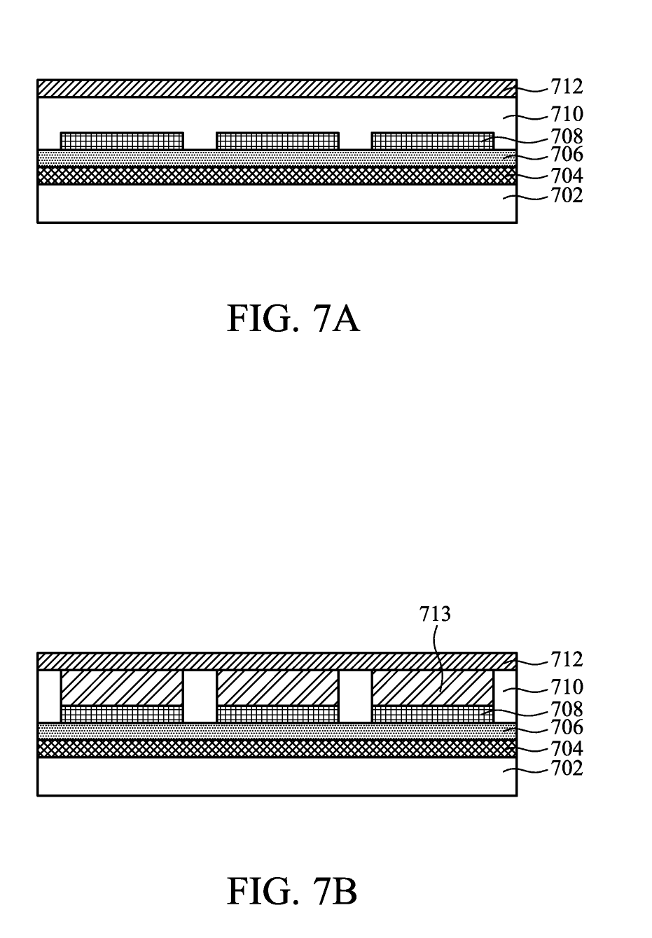

The planar type top emission thermal sensitive display is illustrated in accordance with FIG. 10. Unlike the thermal sensitive display shown in FIG. 8, the embodiment uses a color filter layer to display colorful. Referring to FIG. 10, a first electrode 1004 is disposed on a substrate 1002. A dielectric layer 1006 is disposed on the first electrode 1004 and the substrate 1002. A second electrode 1008, an electric heat converting layer 1012 and third electrode 1010 are disposed on the dielectric layer 1006, wherein the third electrode 1010 is electrically connected to the first electrode 1004 through a plug 1005. The first electrode 1004 and the second electrode 1008 are perpendicular with each other for locating pixels. The second electrode 1008 and the third electrode 1010 are formed of the same material and are fabricated and patterned simultaneously. A reflective layer 1007 is disposed on the second electrode 1008, the electric heat converting layer 1012, the third electrode 1010 and the dielectric layer 1006. A heat induced color changing layer 1014 is disposed on the reflective layer 1007. A color filter layer 1028 is disposed on the heat induced color changing layer 1014.

Each pixel includes at least three sub-pixel regions, such as a first sub-pixel region 1016, a second sub-pixel region 1018 and a third sub-pixel region 1020 in the embodiment, and the color filter layer 1028 includes three or more colorful portions corresponding to the three sub-pixel regions. For example, a first colorful portion 1022 is disposed in the first sub-pixel region 1016, a second colorful portion 1024 is disposed in the second sub-pixel region 1018 and a third colorful portion 1026 is disposed in the third sub-pixel region 1020. In the embodiment, the first colorful portion 1022 is red, the second colorful portion 1024 is green and the third colorful portion 1026 is blue, for example. It is noted that the invention is not limited to the three original colors (red, green and blue). Another embodiment of the invention can comprise four sub-pixel regions and four corresponding colorful portions of a color filter layer, wherein the first color is cyan, the second color is magenta, the third color is yellow and the fourth color is black. In addition, if the reflective layer 1007 is thermally conductive in the embodiment, formation of a heat isolating layer 1011 to isolate adjacent sub-pixels is required.

Accordingly, light with various colors can be generated after filtered by the color filter layer 1028 in the embodiment. The heat induced color changing layer 1014 is heated through the electric heat converting layer 1012 to display a transparent or black pattern. When the heat induced color changing layer 1014 is transparent, a white color pixel can be presented by mixing of light passing the three colorful portions of the color filter layer. The light source is the environment light, viewers are over the display and the electrodes are arranged horizontally in the embodiment. Therefore, the display of the embodiment is called a planar type top emission colorful thermal sensitive display.

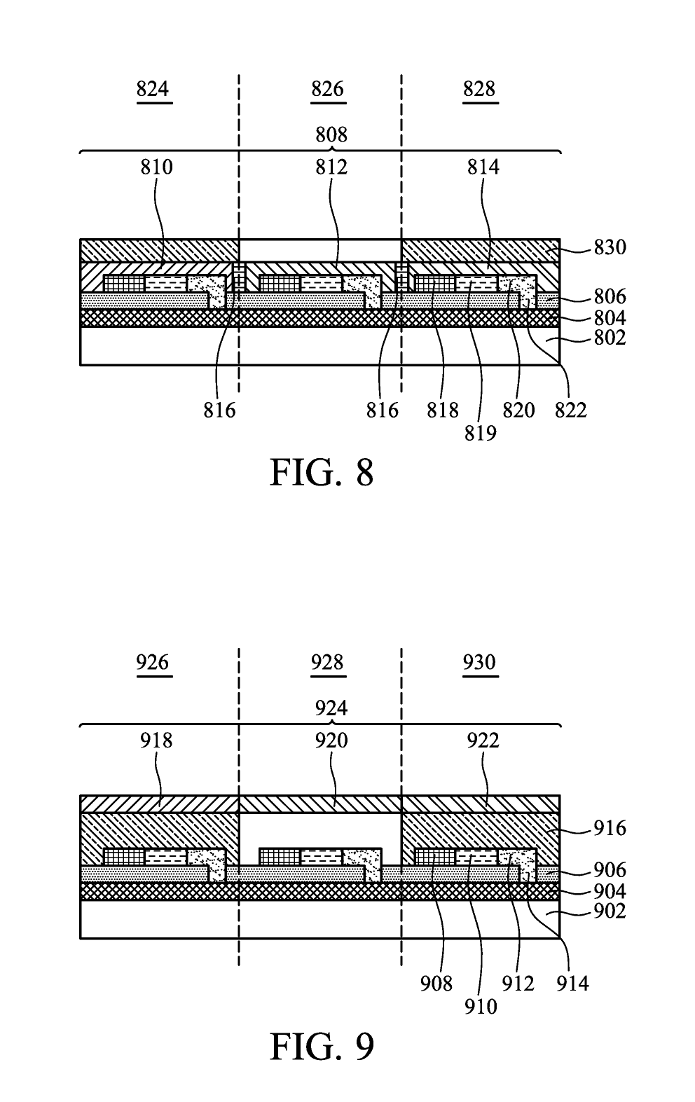

The planar type bottom emission thermal sensitive display is illustrated in accordance with FIG. 11. Unlike the thermal sensitive display shown in FIG. 10, the reflective layer is formed over the heat induced color changing layer in the embodiment. Referring to FIG. 11, a first electrode 1104 is disposed on a substrate 1102. A dielectric layer 1103 is disposed on the first electrode 1106 and the substrate 1102. A second electrode 1106, an electric heat converting layer 1108 and third electrode 1110 are disposed on the dielectric layer 1103, wherein the third electrode 1110 is electrically connected to the first electrode 1104 through a plug 1105. The first electrode 1104 and the second electrode 1106 are perpendicular with each other for locating pixels. The second electrode 1106 and the third electrode 1110 are formed of the same material and are fabricated and patterned simultaneously. A color filter layer 1118 including a first colorful portion 1112, a second colorful portion 1114 and a third colorful portion 1116 is disposed on the dielectric layer 1103, the second electrode 1106, the third electrode 1110 and the electric heat converting layer 1108, wherein the first colorful portion 1112, the second colorful portion 1114 and the third colorful portion 1116 are corresponded to the first pixel region 1107, the second pixel region 1109 and the third pixel region 1111. The color filter 1118 preferably is thermally conductive for heat from the electric heat converting layer 1108 can be transferred to the heat induced color changing layer 1122. A heat isolating layer 1120 is disposed between colorful portions of the color filter layer 1118. A heat induced color changing layer 1122 is disposed on the color filter layer 1118. A reflective layer 1124 is disposed on the heat induced color changing layer 1118. The light source is the environment light, viewers are under the display and the electrodes are arranged horizontally in the embodiment. Therefore, the display of the embodiment is called a planar type bottom emission colorful thermal sensitive display. It is noted that the first electrode 1104, the second electrode 1106, the third electrode 1110, the electric heat converting layer 1108, the dielectric layer 1103 and the substrate 1102 are required to be transparent for light to pass there through these layers.

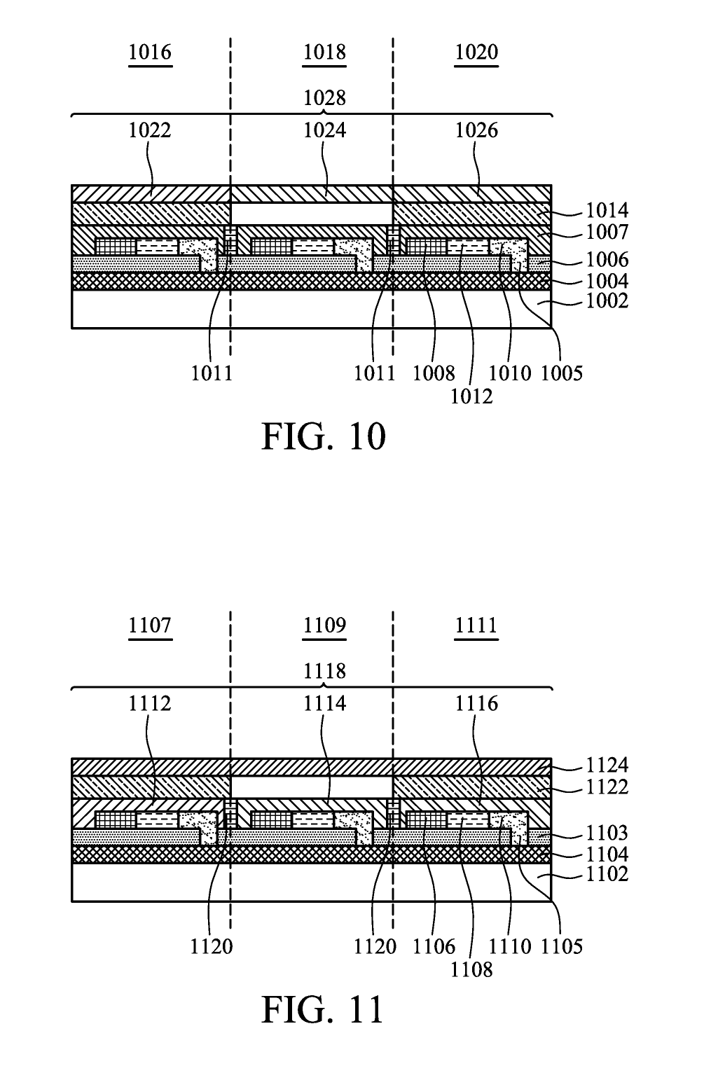

In addition to using a reflective layer and a color filter layer for displays to display various color, the invention further uses the heat induced color changing layer to display colorful. The planar type colorful top emission thermal sensitive display is illustrated in accordance with FIG. 12. A first electrode 1204 is disposed on a substrate 1202. A dielectric layer 1206 is disposed on the first electrode 1204 and the substrate 1202. A second electrode 1208, an electric heat converting layer 1212 and a third electrode 1210 are disposed on the dielectric layer 1206, wherein the third electrode 1210 is electrically connected to the first electrode 1204 through a plug 1211. The first electrode 1204 and the second electrode 1208 are perpendicular with each other for locating pixels. The second electrode 1208 and the third electrode 1210 are formed of the same material and are fabricated and patterned simultaneously. A light absorbing layer 1214, such as graphite, is disposed on the second electrode 1208, the electric heat converting layer 1212, the third electrode 1210 and the dielectric layer 1206. It is noted that the light absorbing layer 1214 preferably is thermally conductive for heat from the electric heat converting layer 1212, transferred to the heat induced color changing layer 1225.

In the embodiment, each pixel includes at least three sub-pixel regions, such as first sub-pixel region 1218, a second sub-pixel region 1220 and a third sub-pixel region 1222. In the embodiment, the heat induced color changing layer 1225 includes three or more colorful portions corresponding to the sub-pixel regions. For example, a first color portion 1224 is disposed in the first sub-pixel region 1218, a second colorful portion 1226 is disposed in the second sub-pixel region 1220 and a third colorful portion 1228 is disposed in the third sub-pixel region 1222. In an example of the invention, the first color portion 1224 is red, the second color portion 1226 is green and the third color portion 1228 is blue. It is noted that the invention is not limited to the three original colors (red, green and blue). Another embodiment of the invention can comprise four sub-pixel regions and four corresponding colorful portions of a heat induced color changing layer, wherein the first color is cyan, the second color is magenta, the third color is yellow and the fourth color is black. In addition, since the light absorbing layer 1214 is thermally conductive in the embodiment, formation of a heat isolating layer 1216 to provide isolation between adjacent sub-pixels is required.

The display can display a white color, blue color, green color, red color or other color when the heat induced color changing layer is heated to present color, and when the heat induced color changing layer discolors due to cooling, a transparent state is generated. Therefore, a viewer over the panel may view the color of the light absorbing layer 1214 (black color).

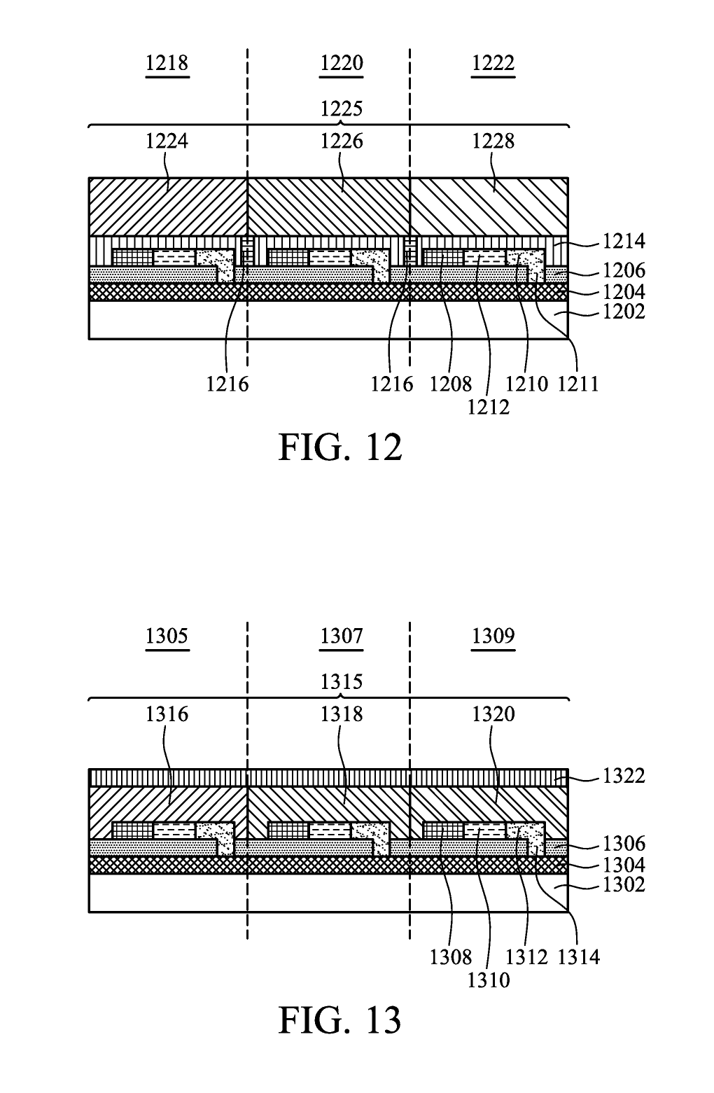

The planar type bottom emission thermal sensitive display is illustrated in accordance with FIG. 13. Unlike the display shown in FIG. 12, the light absorbing layer is disposed over the heat induced color changing layer in this embodiment. Referring to FIG. 13, a first electrode 1304 is disposed on a substrate 1302. A dielectric layer 1306 is disposed on the first electrode 1304 and the substrate 1302. A second electrode 1308, an electric heat converting layer 1310 and a third electrode 1312 are disposed on the dielectric layer 1306, wherein the third electrode 1312 is electrically connected to the first electrode 1304 through a plug 1314. The first electrode 1304 and the second electrode 1308 are perpendicular with each other for locating pixels. The second electrode 1308 and the third electrode 1312 are formed of the same material and are fabricated and patterned simultaneously. A heat induced color changing layer 1315 comprising a first colorful portion 1316, a second colorful portion 1318 and a third colorful portion 1320 is disposed on the second electrode 1308, the third electrode 1312, the electric heat converting layer 1310 and the dielectric layer 1306. The first colorful portion 1316, the second colorful portion 1318 and the third colorful portion 1320 of the heat induced color changing layer 1315 correspond to a first sub-pixel region 1305, a second sub-pixel region 1307 and a third sub-pixel region 1309, respectively. A light absorbing layer 1322 is disposed on the heat induced color changing layer 1315. It is noted that the light absorbing layer 1322 can be not thermally conductive in the embodiment and a heat isolating layer between the color portions of the heat induced color changing layer is not required.

The display can display a white color, blue color, green color, red color or other color when the heat induced color changing layer 1315 is heated to present color. When the heat induced color changing layer 1315 discolors due to cooling, a transparent state is generated so that a viewer at the bottom of the panel may view the color of the light absorbing layer 1322 (black color). It is noted that the first electrode 1304, the second electrode 1308, the third electrode 1312, the electric heat converting layer 1310, the dielectric layer 1306 and the substrate 1302 are required to be transparent for light to pass there through these layers.

Note that although passive matrix displays are disclosed in the embodiments described, the invention can also comprise active matrix displays which provide thin film transistors (TFT) to determine if electrical signals are transferred to the pixels or sub-pixels.

While the invention has been described by way of example and in terms of the preferred embodiments, it is to be understood that the invention is not limited to the disclosed embodiments. It is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A thermal sensitive display, comprising:
a substrate;
a first electrode and a second electrode perpendicular with each other over the substrate;
a electric heat converting layer between the first electrode and the second electrode; and
a heat induced color changing layer, heated by the electric heat converting layer to display pictures.

2. The thermal sensitive display as claimed in claim 1, further comprising:
a dielectric layer disposed on the first electrode and the substrate;
a third electrode on the dielectric layer, wherein the third electrode is electrically connected to the first electrode through a plug, the electric heat converting layer is adjacent to the second and third electrodes, and the second electrode, the electric heat converting layer and the third electrode are arranged in a horizontal direction; and
a reflective layer between the heat induced color changing layer and the dielectric layer.

3. The thermal sensitive display as claimed in claim 2, wherein the reflective layer is formed of material having reflectivity.

4. The thermal sensitive display as claimed in claim 1, wherein the first electrode is disposed on the substrate, the electric heat converting layer is disposed on the first electrode and the substrate, the second electrode is disposed on the electric heat converting layer, and the thermal sensitive display further comprises a reflective layer between the second electrode and the heat induced color changing layer.

5. The thermal sensitive display as claimed in claim 1, further comprising:
a dielectric layer disposed on the first electrode and the substrate;
a third electrode disposed on the dielectric layer, wherein the third electrode is electrically connected to the first electrode through a plug, the electric heat converting layer is adjacent to the second and third electrodes, and the second electrode, the electric heat converting layer and the third electrode are arranged in a horizontal direction; and
a reflective layer disposed on the heat induced color changing layer.

6. The thermal sensitive display as claimed in claim 1, wherein the first electrode is disposed on the substrate, the electric heat converting layer is disposed on the first electrode and the substrate, the second electrode is disposed on the electric heat converting layer, and the thermal sensitive display further comprises a reflective layer disposed on the heat induced color changing layer.

7. The thermal sensitive display as claimed in claim 1, further comprising:
a dielectric layer disposed on the first electrode and the substrate;
a third electrode disposed on the dielectric layer, wherein the third electrode is electrically connected to the first electrode through a plug, the electric heat converting layer is adjacent to the second and third electrodes, and the second electrode, the electric heat converting layer and the third electrode are arranged in a horizontal direction; and
a reflective layer between the heat induced color changing layer and the dielectric layer, wherein the reflective layer comprises a first colorful portion, a second colorful portion and a third colorful portion corresponding to a first sub-pixel portion, a second sub-pixel portion and a third sub-pixel portion, respectively.

8. The thermal sensitive display as claimed in claim 7, wherein the reflective layer is thermally conductive and a heat isolating layer is disposed between the first, second and third colorful portions of the reflective layer.

9. The thermal sensitive display as claimed in claim 7, wherein the first colorful portion is red, the second colorful portion is green and the third colorful portion is blue.

10. The thermal sensitive display as claimed in claim 7, further comprising a fourth colorful portion, and the first color portion is cyan, the second color portion is magenta, the third color portion is yellow and the fourth color portion is black

11. The thermal sensitive display as claimed in claim 1, further comprising:
a dielectric layer disposed on the first electrode and the substrate;
a third electrode disposed on the dielectric layer, wherein the third electrode is electrically connected to the first electrode through a plug, the electric heat converting layer is adjacent to the second and third electrodes, and the second electrode, the electric heat converting layer and the third electrode are arranged in a horizontal direction; and
a reflective layer disposed on the heat induced color changing layer, wherein the reflective layer comprises a first colorful portion, a second colorful portion and a third colorful portion corresponding to a first sub-pixel portion, a second sub-pixel portion and a third sub-pixel portion, respectively.

12. The thermal sensitive display as claimed in claim 1, further comprising:
a dielectric layer disposed on the first electrode and the substrate;
a third electrode disposed on the dielectric layer, wherein the third electrode is electrically connected to the first electrode through a plug, the electric heat converting layer is adjacent to the second and third electrodes, and the second electrode, the electric heat converting layer and the third electrode are arranged in a horizontal direction;
a reflective layer between the heat induced color changing layer and the dielectric layer; and
a color filter layer disposed on the heat induced color changing layer, wherein the color filter layer comprises a first colorful portion, a second colorful portion and a third colorful portion corresponding to a first sub-pixel portion, a second sub-pixel portion and a third sub-pixel portion, respectively.

13. The thermal sensitive display as claimed in claim 1, further comprising:
a dielectric layer disposed on the first electrode and the substrate;
a third electrode disposed on the dielectric layer, wherein the third electrode is electrically connected to the first electrode through a plug, the electric heat converting layer is adjacent to the second and third electrodes, and the second electrode, the electric heat converting layer and the third electrode are arranged in a horizontal direction;
a reflective layer disposed on the heat induced color changing layer; and
a color filter layer disposed between the heat induced color changing layer and the dielectric layer, wherein the color filter layer comprises a first colorful portion, a second colorful portion and a third colorful portion corresponding to a first sub-pixel portion, a second sub-pixel portion and a third sub-pixel portion, respectively.

14. The thermal sensitive display as claimed in claim 13, wherein the color filter layer is thermally conductive and a heat isolating layer is disposed between the first colorful portion, the second colorful portion and the third colorful portion of the color filter layer.

15. The thermal sensitive display as claimed in claim 1, further comprising:
a dielectric layer disposed on the first electrode and the substrate;
a third electrode disposed on the dielectric layer, wherein the third electrode is electrically connected to the first electrode through a plug, the electric heat converting layer is adjacent to the second and third electrodes, and the second electrode, the electric heat converting layer and the third electrode are arranged in a horizontal direction; and
a light absorbing layer disposed on the dielectric layer, wherein the light absorbing layer covers the second electrode, the electric heat converting layer and the third electrode,
wherein the heat induced color changing layer is disposed on the light absorbing layer, and the heat induced color changing layer comprises a first colorful portion, a second colorful portion and a third colorful portion corresponding to a first sub-pixel portion, a second sub-pixel portion and a third sub-pixel portion, respectively.

16. The thermal sensitive display as claimed in claim 15, wherein the light absorbing layer is black.

17. The thermal sensitive display as claimed in claim 1, further comprising:
a dielectric layer disposed on the first electrode and the substrate;
a third electrode disposed on the dielectric layer, wherein the third electrode is electrically connected to the first electrode through a plug, the electric heat converting layer is adjacent to the second and third electrodes, and the second electrode, the electric heat converting layer and the third electrode are arranged in a horizontal direction; and
a light absorbing layer disposed on the dielectric layer,
wherein the heat induced color changing layer is disposed between the dielectric layer and the light absorbing layer, and the heat induced color changing layer comprises a first colorful portion, a second colorful portion and a third colorful portion corresponding to a first sub-pixel portion, a second sub-pixel portion and a third sub-pixel portion, respectively.

18. The thermal sensitive display as claimed in claim 1, wherein heat induced color changing layer is a Leuco dye.

19. The thermal sensitive display as claimed in claim 1, wherein the thermal sensitive display is a passive matrix display.

20. The thermal sensitive display as claimed in claim 1, wherein the thermal sensitive display is an active matrix display.
